(19) United States
(12) Patent Application Publication
(10) Pub. No.: US 2026/0081795 A1
(43) Pub. Date: Mar. 19, 2026

(54) SYSTEMS, METHODS, AND APPARATUS FOR TRUSTED CONFIDENTIAL COMPUTING MESH

(71) Applicant: Intel Corporation, Santa Clara, CA (US)

(72) Inventors: Ramki Krishnan, Cupertino, CA (US); Ned M. Smith, Beaverton, OR (US); Bala Siva Sai Akhil Malepati, Sunnyvale, CA (US)

(73) Assignee: Intel Corporation, Santa Clara, CA (US)

(21) Appl. No.: 19/402,472

(22) Filed: Nov. 26, 2025

Related U.S. Application Data
(60) Provisional application No. 63/728,009, filed on Dec. 4, 2024.

(51) Int. Cl. H04L 9/40; H04L 9/32

(52) U.S. Cl. CPC H04L 9/40; H04L 9/3263; H04L 9/3297

(57) ABSTRACT

This disclosure relates generally to confidential computing and, more particularly, to trusted confidential computing meshes. An example apparatus for attestation verification comprises interface circuitry, machine readable instructions, and programmable circuitry to execute the machine readable instructions to obtain verification data corresponding to a network application from a server, verify the network application based on policy data included in the verification data, if verification of the network application is successful, allow network traffic between the programmable circuitry and the network application, and if the verification of the network application is not successful, at least one of isolate the network application or prevent traffic between the programmable circuitry and the network application.

### RELATED APPLICATION

This patent claims the benefit of U.S. Provisional Patent Application No. 63/728,009, which was filed on December 4, 2024. U.S. Provisional Patent Application No. 63/728,009 is hereby incorporated herein by reference in its entirety. Priority to U.S. Provisional Patent Application No. 63/728,009 is hereby claimed.

### BACKGROUND

Confidential computing workloads can be distributed to form workload meshes where members of the mesh can interact with other members frequently. Members of the mesh can become misconfigured or compromised by malware. Centralized verification services are typically used to detect misconfigured or compromised members and to disqualify/isolate them from the mesh.

### BRIEF DESCRIPTION OF THE DRAWINGS

FIG. 1 is a block diagram of an example system utilizing a confidential computing mesh.

FIG. 2 is a block diagram of an example implementation of the verification circuitry of FIG. 1.

FIG. 3 is a flowchart representative of example machine readable instructions and/or example operations that may be executed, instantiated, and/or performed by example programmable circuitry to implement the verification circuitry of FIG. 2.

FIGS. 4A and 4B are conceptual diagrams illustrating the example system of FIG. 1 during code injection attacks.

FIG. 5 is a diagram of an example application in a microservice-based system.

FIG. 6 is a flowchart representative of example machine readable instructions and/or example operations that may be executed, instantiated, and/or performed by example programmable circuitry to perform configuration of the application of FIG. 5.

FIG. 7 is a flowchart representative of example machine readable instructions and/or example operations that may be executed, instantiated, and/or performed by example programmable circuitry to implement a service of the example application of FIG. 5.

FIG. 8 is a block diagram of an example processing platform including programmable circuitry structured to execute, instantiate, and/or perform the example machine readable instructions and/or perform the example operations of FIGS. 3, 6, and 7 to implement the verification circuitry 108 of FIG. 2.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 3, 6, and 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts.

### DETAILED DESCRIPTION

Confidential computing (CC) workloads can be distributed to form a workload mesh where the members of the mesh may interact freely with other members frequently. The mesh typically is connected via a secure channel technology such as Transport Layer Security (TLS), Internet Protocol Security (IPSEC), Sigma, etc. However, deployed mesh nodes may nevertheless become misconfigured or compromised by malware. Such misconfigured/compromised nodes can disqualify a workload node from participating in the mesh. However, detection of unacceptable/vulnerable node states isn't practically possible without trusted container capabilities (e.g., INTEL® trusted domain extensions (TDX), Arm Confidential Compute Architecture (CCA), AMD Secure Encrypted Virtualization (SEV)). Trusted container attestations utilized for vulnerable node detection do not scale using traditional attestation topologies that use a central verifier service (e.g., INTEL® Trust Authority). Verifier architectures (such as those based on IETF RFC9334) expect the attestation verifier to be complex to account for the challenges of operating in a heterogeneous multi-vendor environment.

Systems, methods, and apparatus disclosed herein distribute attestation verifier capabilities to workload nodes (e.g., services) and enforce a mesh membership policy that ensures that nodes that are configured correctly may join (e.g., and nodes that are not configured correctly may be prevented from joining). In some examples, periodic re-checking is applied to detect possible subsequent compromises. Node-to-node interaction may trigger the re-check, and if unsatisfactory results are detected, may isolate "out of compliance" node(s). Example workload mesh "self-enforcement" of node integrity enables the mesh to operate nearly autonomously while also being able to scale according to the needs of mesh orchestration and dynamics imposed by its resource management and control layer.

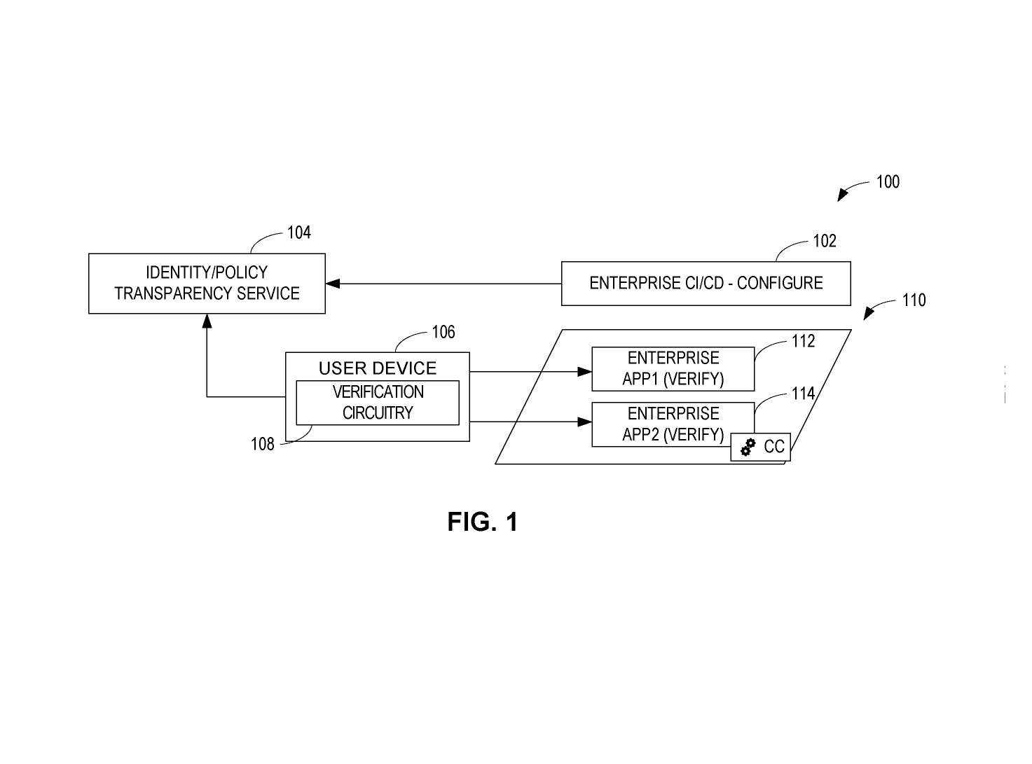

FIG. 1 is a block diagram of an example system 100 utilizing a confidential computing mesh. FIG. 1 includes an example enterprise Continuous Integration (CI)/Continuous Deployment (CD) 102, an example Identity/Policy Transparency (I/PT) service 104, an example user device (e.g., enterprise user/3^{rd} party device) 106 including example verification circuitry 108, and an example CC environment 110. In some examples, the verification circuitry 108 is implemented by an example plugin. The example CC environment 110 includes an example first enterprise application 112 and an example second enterprise application 114.

In a control plane, identities (workloads, devices, users) and policies (connectivity, etc.) for verification are populated by the example enterprise CI/CD 102 in the example I/PT service 104. Identities (e.g., identity information) can include a code hash, an organization code signing public key certificate, etc. The example I/PT service 104 utilizes tamper-proof historical records. In some examples, a memory of the I/PT service 104 can be appended by the enterprise CI/CD 102 (e.g., the enterprise CI/CD 102 can append the tamper-proof historical records of the I/PT service 104). In some examples, the user device 106 has read-only access to the tamper-proof historical records of the I/PT service 104. The example verification circuitry 108 (e.g., the relying party) fetches verification policies/identities from the I/PT service 104 in the control plane. In a data plane, these distributed trusted verification policies are evaluated. In some examples, the trusted verification policies are evaluated whenever the verification circuitry 108 connects to the peer enterprise applications 112-114 using a transport connection (e.g., attested TLS, etc.). Traffic may only allowed to proceed to the enterprise applications 112-114 upon successful verification according to the trusted verification policies.

Disclosed examples may be applicable to a variety of particular use cases. For example, disclosed examples may be implemented in an enterprise work from home employee virtual private network (VPN). For instance, disclosed examples may be implemented between an enterprise customer employee and an egress/ingress Secure Access Service Edge (SASE) typically via TLS connection, or between Egress/Ingress SASE and a cloud service app, typically via a TLS connection. Other examples use cases include an enterprise data center (DC) (branch or main) VPN. For example, disclosed examples may be implemented between enterprise customer employees and egress SASE, between egress SASE in DC and ingress SASE in the cloud, or between ingress SASE in the cloud and a cloud service app, each of which typically via a TLS connection. Another example use case is between an enterprise branch router and an enterprise main router via IPSEC tunnel to ensure enterprise branch DC to main DC secure connectivity.

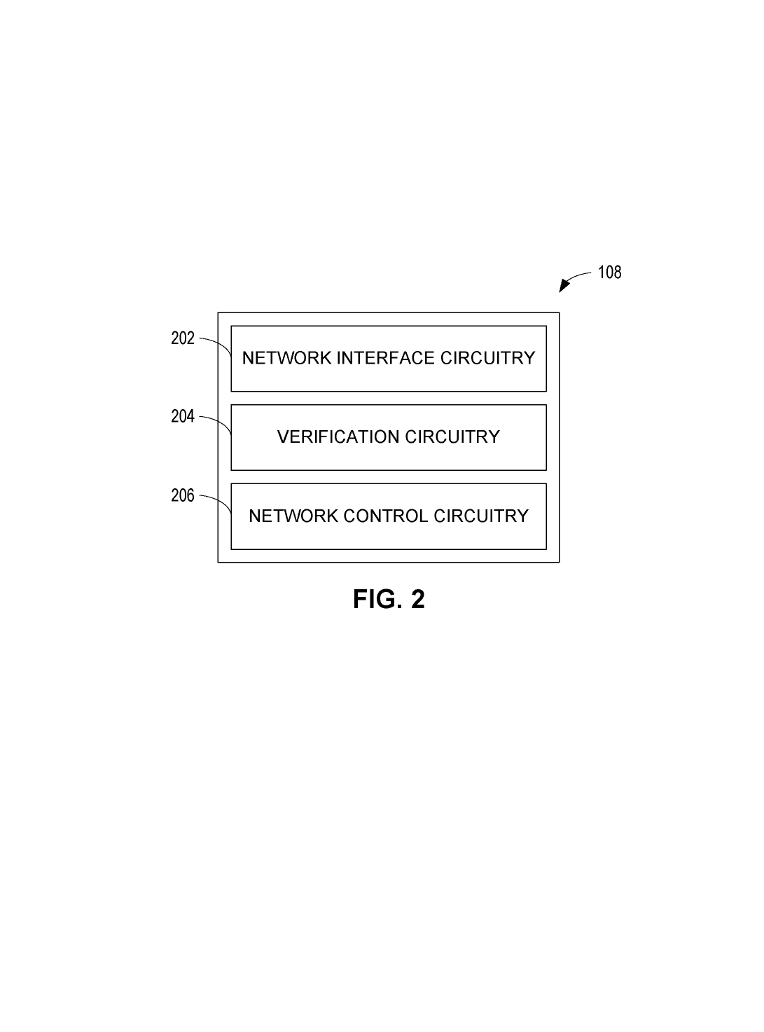

FIG. 2 is a block diagram of an example implementation of the verification circuitry 108 of FIG. 1 to perform attestation verification. The verification circuitry 108 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the verification circuitry 108 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. In some examples, the verification circuitry includes network interface circuitry 202, verification circuitry 204, and network control circuitry 206.

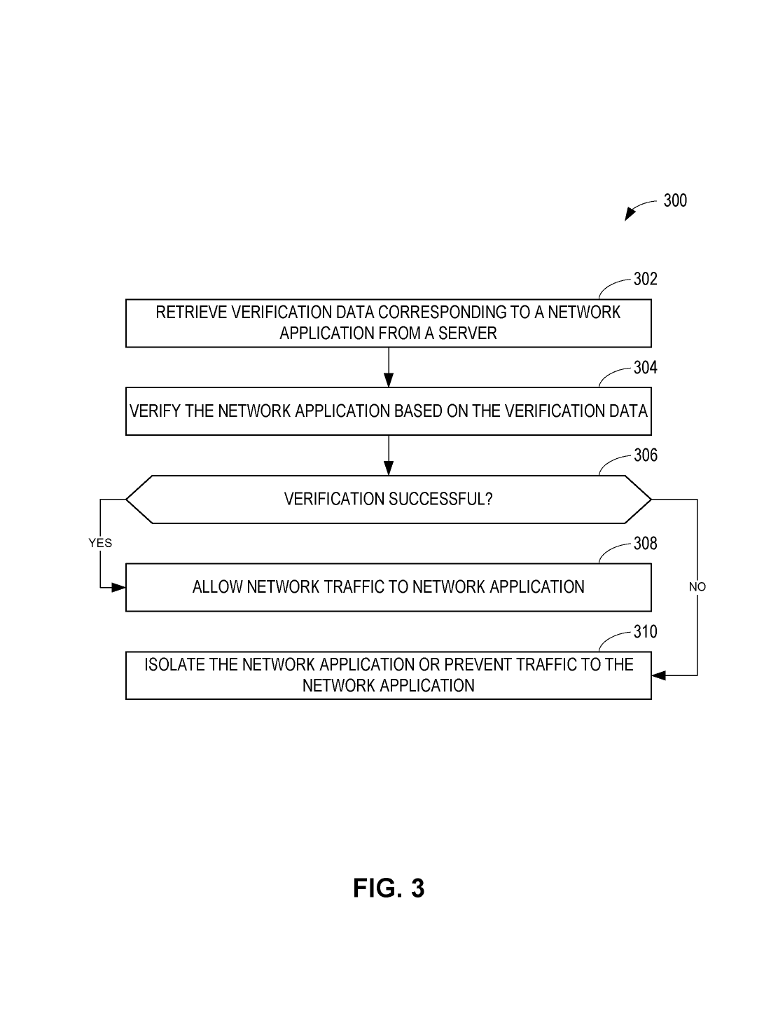

In some examples, the network interface circuitry 202 is instantiated by programmable circuitry executing network interface circuitry instructions and/or configured to perform operations such as those represented by the flowchart(s) of FIG. 3.

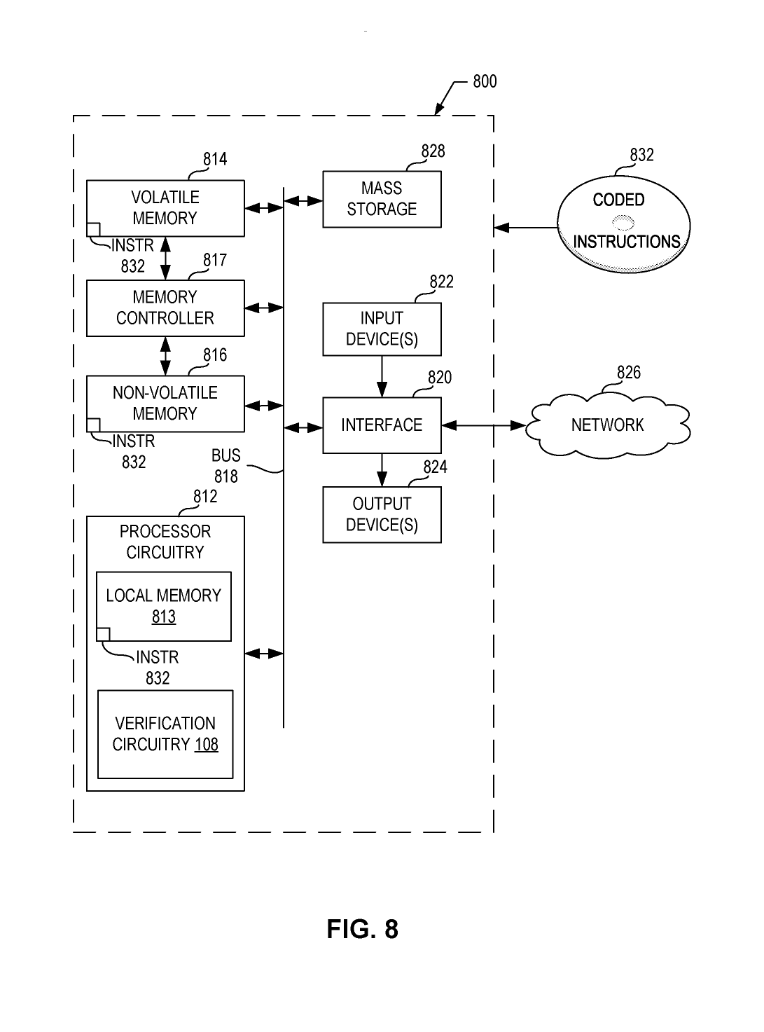

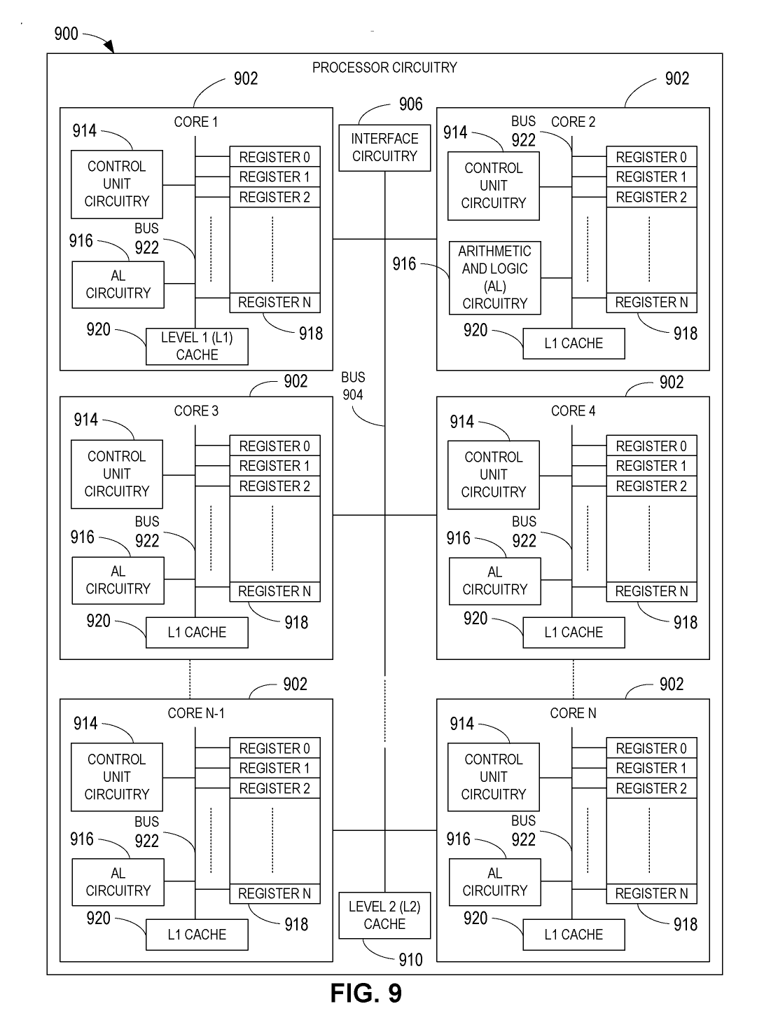

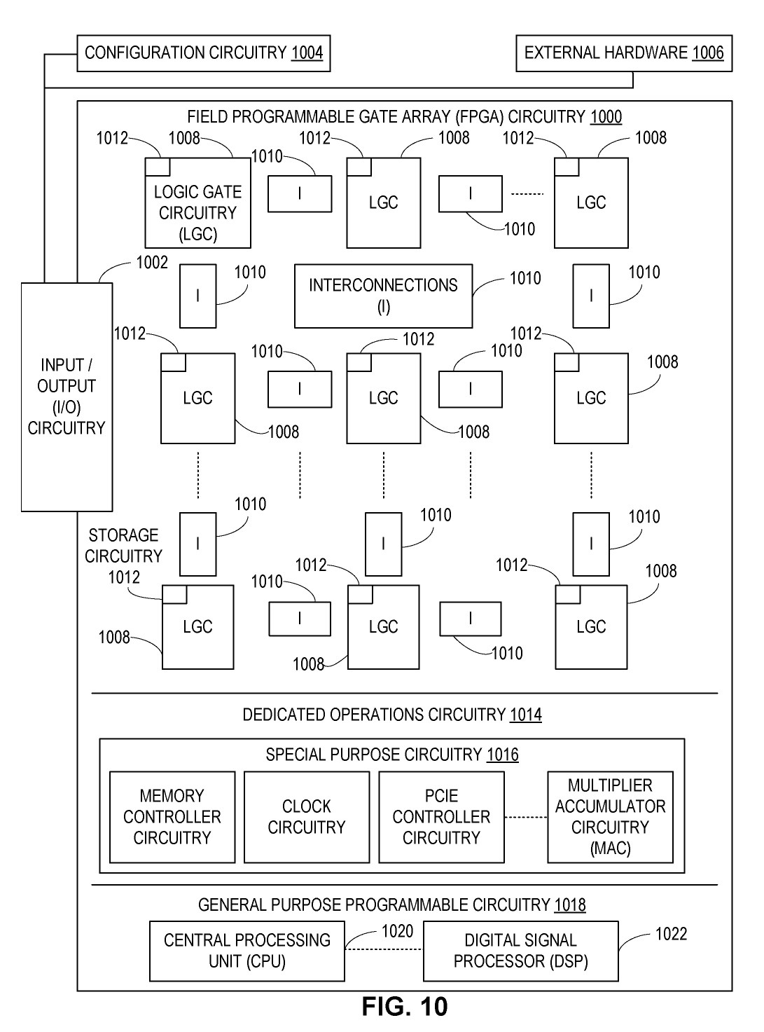

In some examples, the verification circuitry 108 includes means for interfacing with a network. For example, the means for interfacing with a network may be implemented by network interface circuitry 202. In some examples, the network interface circuitry 202 may be instantiated by programmable circuitry such as the example programmable circuitry 812 of FIG. 8. For instance, the network interface circuitry 202 may be instantiated by the example microprocessor 900 of FIG. 9 executing machine executable instructions such as those implemented by at least block 302 of FIG. 3. In some examples, the network interface circuitry 202 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the network interface circuitry 202 may be instantiated by any other combination of hardware, software, and/or firmware. For example, the network interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the verification circuitry 204 is instantiated by programmable circuitry executing verification instructions and/or configured to perform operations such as those represented by the flowchart(s) of FIG. 3.

In some examples, the verification circuitry 108 includes means for verification. For example, the means for verification may be implemented by verification circuitry 204. In some examples, the verification circuitry 204 may be instantiated by programmable circuitry such as the example programmable circuitry 812 of FIG. 8. For instance, the verification circuitry 204 may be instantiated by the example microprocessor 900 of FIG. 9 executing machine executable instructions such as those implemented by at least block 304 of FIG. 3. In some examples, the verification circuitry 204 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the verification circuitry 204 may be instantiated by any other combination of hardware, software, and/or firmware. For example, the verification circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the network control circuitry 206 is instantiated by programmable circuitry executing network control instructions and/or configured to perform operations such as those represented by the flowchart(s) of FIG. 3.

In some examples, the verification circuitry 108 includes means for controlling a network connection. For example, the means for controlling a network connection may be implemented by network control circuitry 206. In some examples, the network control circuitry 206 may be instantiated by programmable circuitry such as the example programmable circuitry 812 of FIG. 8. For instance, the network control circuitry 206 may be instantiated by the example microprocessor 900 of FIG. 9 executing machine executable instructions such as those implemented by at least blocks 306, 308, and 310 of FIG. 3. In some examples, network control circuitry 206 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the network control circuitry 206 may be instantiated by any other combination of hardware, software, and/or firmware. For example, the network control circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the verification circuitry 108 of FIG. 1 is illustrated in FIG. 2, one or more of the elements, processes, and/or devices illustrated in FIG. 2 may be combined, divided, re-arranged, omitted, eliminated, and/or implemented in any other way. Further, the example network interface circuitry 202, the example verification circuitry 204, the example network control circuitry 206, and/or, more generally, the example verification circuitry 108 of FIG. 2, may be implemented by hardware alone or by hardware in combination with software and/or firmware. Thus, for example, any of the example network interface circuitry 202, the example verification circuitry 204, the example network control circuitry 206, and/or, more generally, the example verification circuitry 108, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example verification circuitry 108 of FIG. 2 may include one or more elements, processes, and/or devices in addition to, or instead of, those illustrated in FIG. 2, and/or may include more than one of any or all of the illustrated elements, processes and devices.

FIG. 3 is a flowchart representative of example machine readable instructions and/or example operations 300 that may be executed, instantiated, and/or performed by programmable circuitry to perform attestation verification. The example machine-readable instructions and/or the example operations 300 of FIG. 3 begin at block 302, at which the network interface circuitry 202 retrieves verification data corresponding to a network application from a server. For example, the network interface circuitry 202 can retrieve verification data corresponding to the first enterprise application 112 from the identity/policy transparency service 104. In some examples, the server includes a memory to store the verification data corresponding to the network application. Further, in some examples, the server is coupled to a control plane, and the server further includes a configurator to append the memory with second verification data corresponding to a second network application.

At block 304, the verification circuitry 204 verifies the network application based on the verification data. For example, the verification circuitry 204 can verify the first enterprise verification 112 based on the verification data retrieved from the identity/policy transparency service 104.

At block 306, the network control circuitry 206 determines whether verification was successful. If verification was successful, control proceeds to block 308. Alternatively, if verification was not successful, control proceeds to block 310. For example, if the verification circuitry 204 successfully verifies the first enterprise application 112 the network control circuitry can determine that verification was successful and control can proceed to block 308.

At block 308, the network control circuitry 206 allows network traffic to the network application. For example, the network control circuitry 206 allows network traffic to the first enterprise application 112.

At block 310, the network control circuitry 206 isolates the network application or prevents traffic to the network application. For example, the network control circuitry 206 isolates the first enterprise application 112 and prevents traffic to the first enterprise application 112.

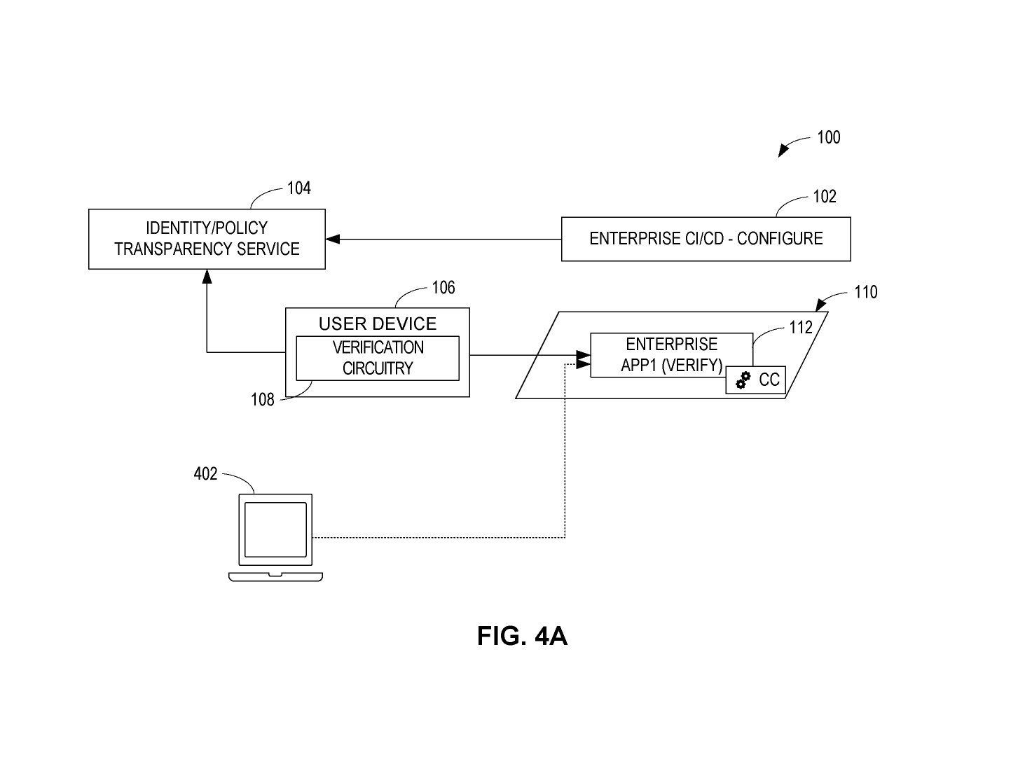

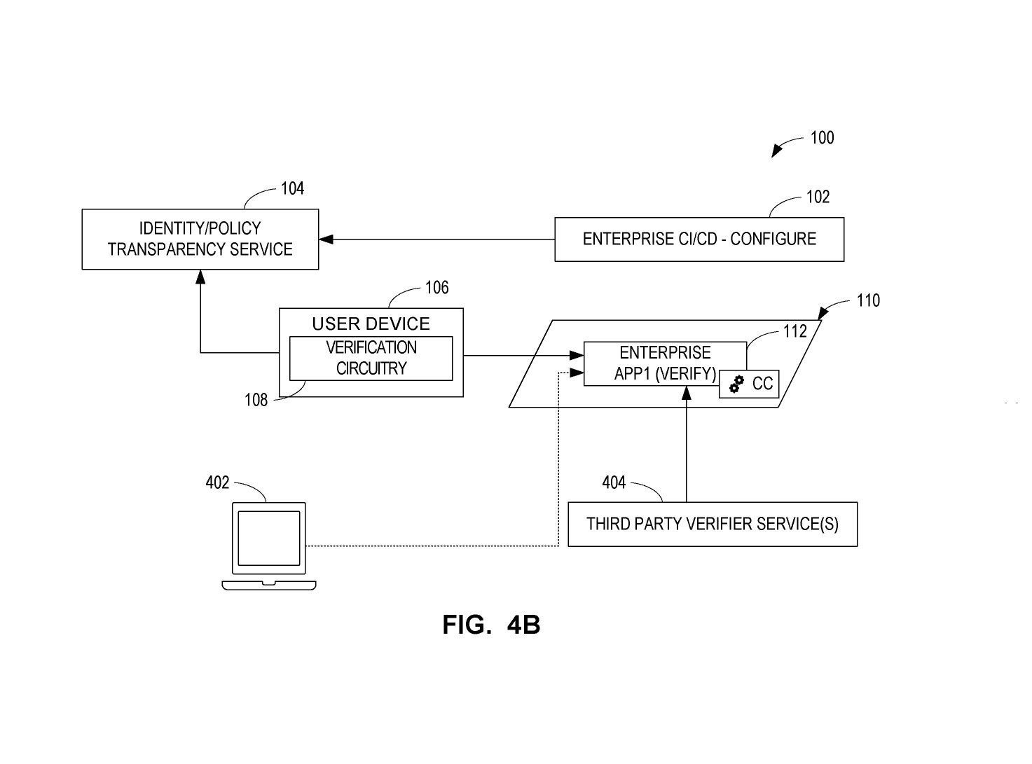

FIG. 4A is a conceptual diagram illustrating the example system 100 during a code injection attack. In the illustrated example of FIG. 4A, a malicious actor 402 injects malicious code into the enterprise application 112. In some examples, the verification circuitry 108 detects any code changes on the server side (e.g., every time an application program interface (API) call occurs). As part of the API call, the verification circuitry 108 performs (e.g., calculates) a run time integrity measurement of the confidential computing environment 110 and compares it against allowed policy retrieved from the identity/policy transparency service 104. When the integrity measurement does not satisfy the policy (e.g., does not satisfy a threshold associated with the verification data), the enterprise application 112 is isolated. FIG. 4B is a conceptual diagram illustrating the example system 100 including a third party verification service 404 during a code injection attack by the malicious actor 402. In the illustrated example of FIG. 4B, the third-party verifier service 404 performs (e.g., calculates, verifies, reverifies, etc.) run time integrity measurements of the confidential computing environment 110 and compares it against allowed server workload identity. When the integrity measurement does not match the allowed workload identity, traffic is no longer permitted to the enterprise application 112.

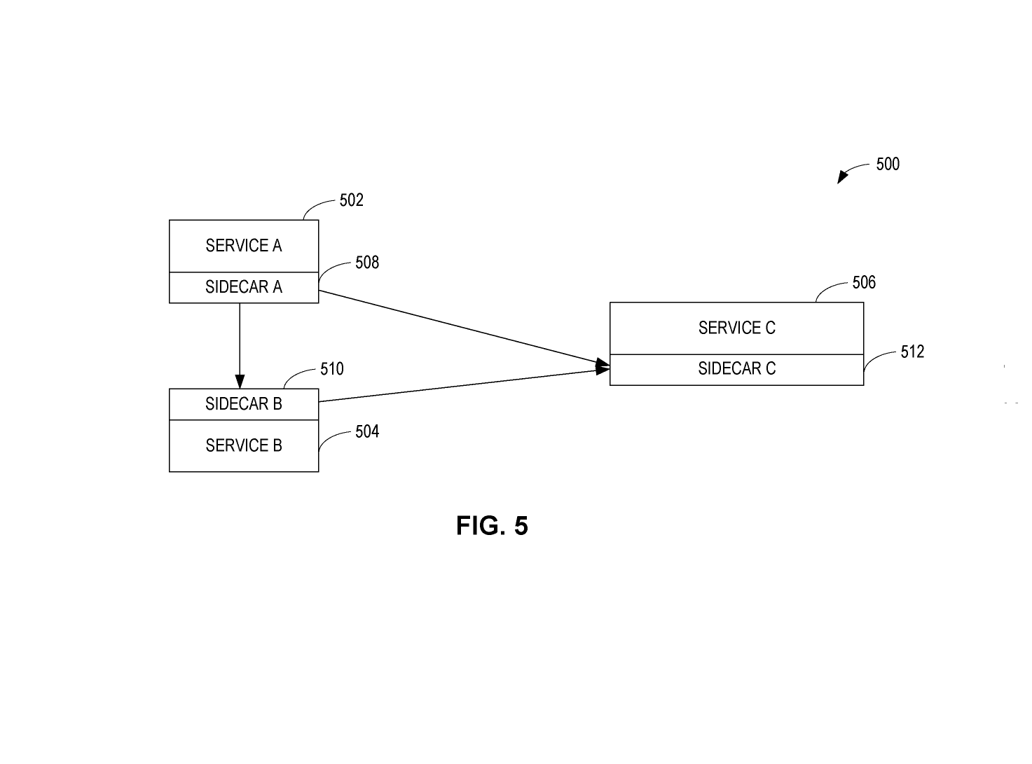

FIG. 5 is a diagram of an example application 500 in a microservice-based system. The example application 500 includes a first service 502, a second service 504, and a third service 506. In the illustrated example of FIG. 5 traffic flows from the first service 502 to the second and third services 504, 506, and from the second service 504 to the third service 506. As used herein, a sidecar of an application is a process that is separate from the application and that extends the functionality of said application. In some examples, each service 502, 504, 506 includes a sidecar 508, 510, 512. Interservice communication between the services 502, 504, 506 may be routed through their sidecars 508, 510, 512, which may perform mesh verification functions. The sidecars 508, 510, 512 may be populated with verification policies and identifiers from a control plane. These verification policies may be evaluated, in a data plane, by the sidecars 508, 510, 512 to control interservice communication between their corresponding service 502, 504, 506 and other services 502, 504, 506 in the mesh. In some examples, each of the sidecars 508, 510, 512 acts as a network proxy for its associated service 502, 504, 506 so that all inter-service communication involving the services 502, 504, 506 is routed through its sidecar 508, 510, 512. The sidecars 508, 510, 512 intercept inter-service communications (e.g., intercept all inter-service communications) to and from its service 502, 504, 506. Because the sidecar 508, 510, 512 executes its processes separately from the services 502, 504, 506 itself, the service 502, 504, 506 functions are not impacted by the sidecar 508, 510, 512 functions and the sidecar 508, 510, 512 functions are not impacted by the service 502, 504, 506 functions.

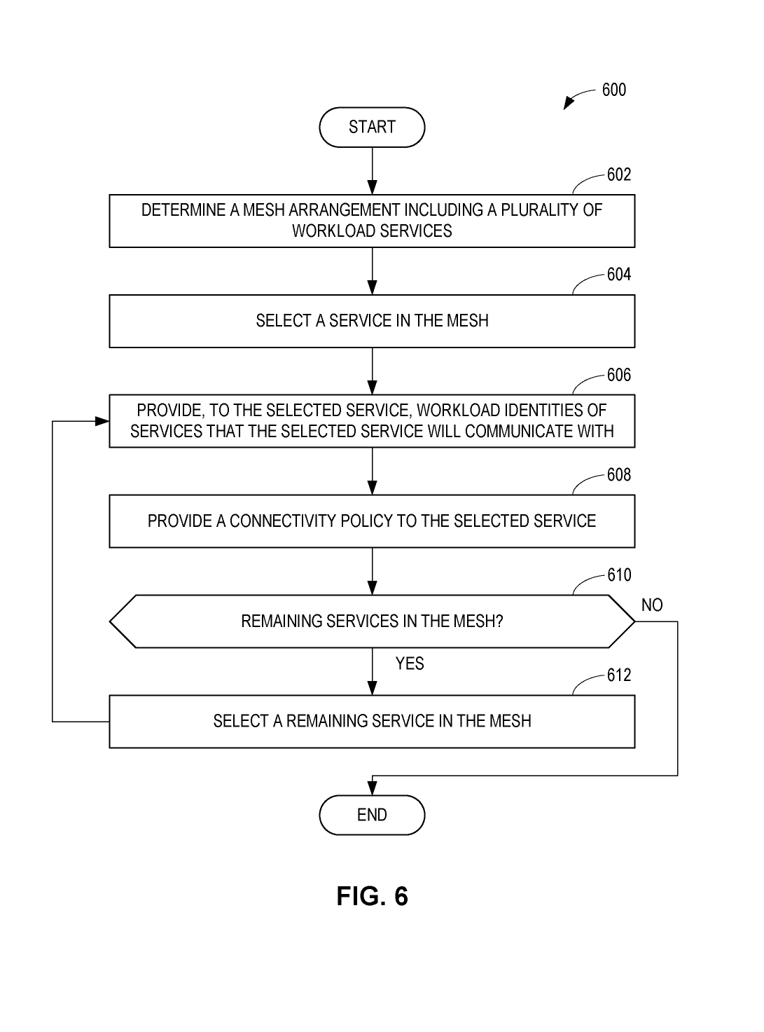

FIG. 6 is a flowchart illustrating an example process 600 to perform configuration of the application 500 of FIG. 5. At block 602, a mesh arrangement including a plurality of workload services is determined. In the example application 500 of FIG. 5, the first, second, and third services are the workload services. At block 604, a service is selected from the mesh. For example, the second service 504 can be selected. At block 606, the selected service is provided with workload identities of services that the selected service will communicate with. This includes any service that will have one-way or two-way traffic flow with the selected service. For example, the second service 504 will be provided with the workload identities of both the first and third services 502, 506. At block 608, the selected service is provided with a connectivity (e.g., verification) policy corresponding to itself. At block 610, whether there are remaining services in the mesh that have not be populated with the workload identities and connectivity policies is determined. If there are remaining services (e.g., block 610 returns a result of YES), one of the remaining services is selected at block 612 and the process 600 returns to block 606. If there are no remaining services (e.g., block 610 returns a result of NO), then the example process 600 terminates.

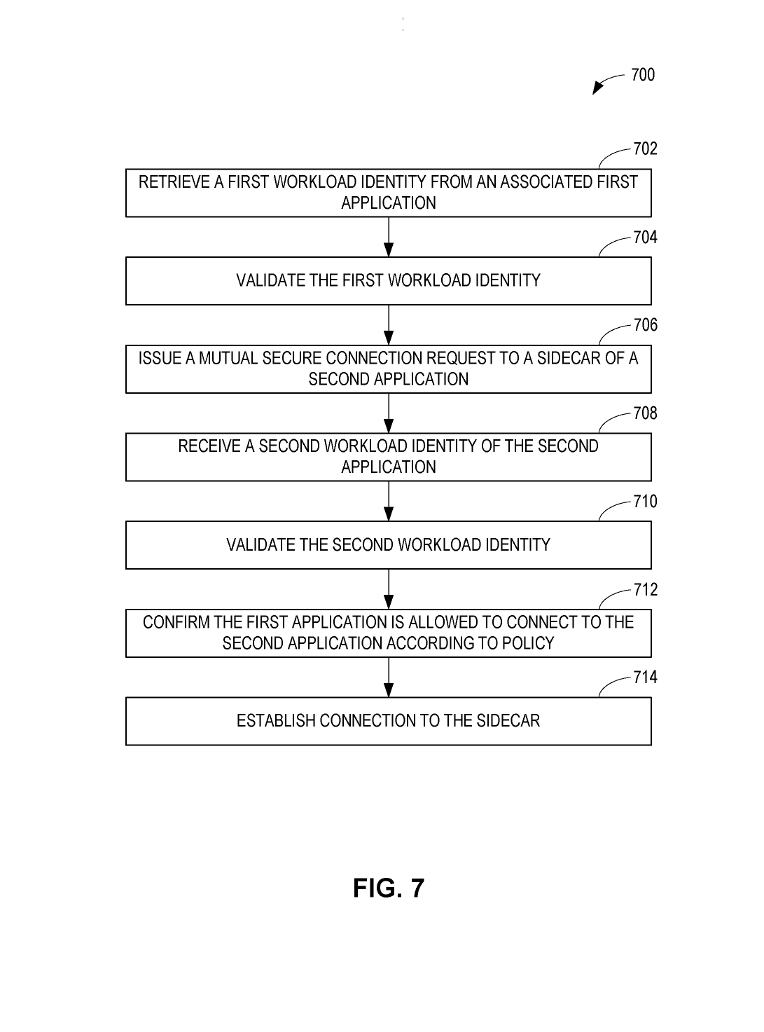

FIG. 7 is a flowchart illustrating an example process 700 implemented by a service in an example application (e.g., a trusted confidential computing mesh). For example, the example process may be implemented by a sidecar of a first application in an example application. The process 700 begins at block 702, where a first workload identity of the first application is retrieved. At block 704, the first workload identity is validated. At block 706, a mutual secure connection request is issued to a sidecar of a second application. At block 708, a second workload identity of the second application is received from the sidecar of the second application. At block 710, the second workload identity is validated. At block 712, it is confirmed that the first application is allowed to connect to the second application according to policy. For example, the first workload identity and the second workload identity may be used as inputs to determine whether the connectivity policy permits traffic between the two applications. At block 714, a connection between the sidecars is established.

Flowchart(s) representative of example machine readable instructions, which may be executed by programmable circuitry to implement and/or instantiate the verification circuitry 108 of FIG. 2 and/or representative of example operations which may be performed by programmable circuitry to implement and/or instantiate the verification circuitry 108 of FIG. 2, are shown in FIGS. 3, 6, and 7. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3, 6, and 7, many other methods of implementing the example verification circuitry 108 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 3, 6, and 7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/ or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 8 is a block diagram of an example programmable circuitry platform 800 structured to execute and/or instantiate the example machine-readable instructions and/or the example operations of FIGS. 3, 6, and 7 to implement the verification circuitry 108 of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad^{TM}), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, VPUs, DSPs, and/or microcontrollers from any desired family or manufacturer. The programmable circuitry 812 may be implemented by one or more semiconductor based (e.g., silicon based) devices. In this example, the programmable circuitry 812 implements the verification circuitry 108 of FIG. 1.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 3, 6, and 7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 3, 6, and 7 to effectively instantiate the circuitry of FIG. 2 as logic circuits to perform operations corresponding to those machine readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 3, 6, and 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of the cores 902 (e.g., each of the cores 902) and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. The core (e.g., each of the cores) 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

The core (e.g., each of the cores) 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 3, 6, and 7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3, 6, and 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3, 6, and 7. As such, the FPGA circuitry 1000 may be configured and/or structured to effectively instantiate some or all of the operations/functions corresponding to the machine readable instructions of the flowchart(s) of FIGS. 3, 6, and 7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 3, 6, and 7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 3, 6, and 7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

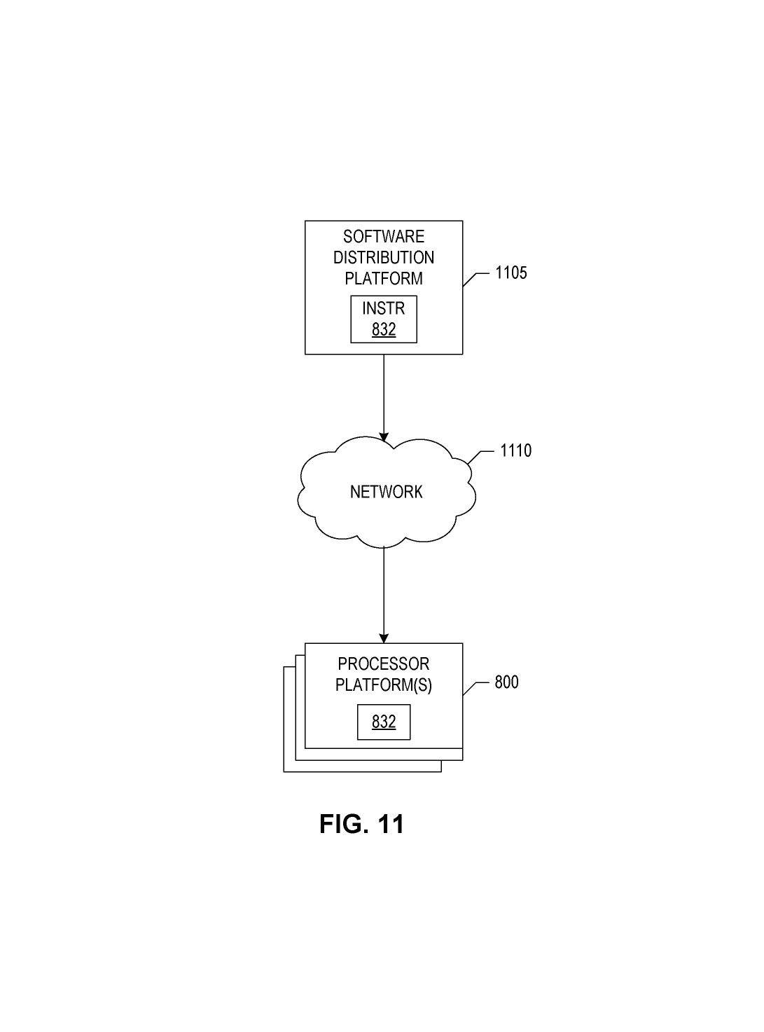

Although FIGS. 10 and 11 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 3, 6, and 7 to perform first operation(s)/function(s), the FPGA circuitry 1000 of FIG. 10 may be configured and/or structured to perform second operation(s)/function(s) corresponding to a second portion of the machine readable instructions represented by the flowcharts of FIGS. 3, 6, and 7, and/or an ASIC may be configured and/or structured to perform third operation(s)/function(s) corresponding to a third portion of the machine readable instructions represented by the flowcharts of FIGS. 3, 6, and 7.

It should be understood that some or all of the circuitry of FIG. 2 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 3, 6, and 7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIGS. 3, 6, and 7, may be downloaded to the example programmable circuitry platform 800, which is to execute the machine readable instructions 832 to implement the verification circuitry 108. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/- 10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time + 1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to enable attestation verification on workload nodes are disclosed herein. Further examples and combinations thereof include the following:

Example 1 includes an apparatus for attestation verification comprising interface circuitry, machine readable instructions, and programmable circuitry to execute the machine readable instructions to obtain verification data corresponding to a network application from a server, verify the network application based on policy data included in the verification data, if verification of the network application is successful, allow network traffic between the programmable circuitry and the network application, and if the verification of the network application is not successful, at least one of isolate the network application or prevent traffic between the programmable circuitry and the network application.

Example 2 includes the apparatus of example 1, wherein the verification data includes identity information including a code hash or an organization code signing public key certificate.

Example 3 includes the apparatus of any one or more of examples 1-2, wherein the programmable circuitry has read-only access to the server.

Example 4 includes the apparatus of any one or more of examples 1-3, wherein the machine readable instructions cause the programmable circuitry to reverify the network application in response to an API call.

Example 5 includes the apparatus of example 4, wherein reverifying the network application includes calculating a run time integrity measurement of the network application and comparing it to the verification data.

Example 6 includes the apparatus of example 5, wherein if the run time integrity measurement does not satisfy a threshold associated with the verification data, the machine readable instructions causes the programmable circuitry to isolate the network application.

Example 7 includes a system comprising a server including a memory to store verification data corresponding to a network application, and a client including a machine-readable instructions to cause the client to obtain the verification data corresponding to the network application from the memory, verify the network application based on policy data included in the verification data, if verification of the network application is successful, allow network traffic between the client and the network application, and if the verification of the network application is not successful, at least one of isolate the network application or prevent traffic between the client and the network application.

Example 8 includes the system of example 7, wherein the verification data includes identity information including a code hash or an organization code signing public key certificate.

Example 9 includes the apparatus of any one or more of examples 7-8, wherein the network application is a first network application and wherein the server is coupled to a control plane, the server further including a configurator to append the memory with second verification data corresponding to a second network application.

Example 10 includes the apparatus of any one or more of examples 7-9, wherein the client has read-only access to the server.

Example 11 includes the apparatus of any one or more of examples 7-10, wherein a plurality of clients have read-only access to the server.

Example 12 includes the apparatus of any one or more of examples 7-11, further including wherein the machine-readable instructions cause the client to reverify the network application in response to an API call.

Example 13 includes the system of example 12, wherein reverifying the network application includes calculating a run time integrity measurement of the network application and comparing it to the verification data.

Example 14 includes the system of example 13, wherein if the run time integrity measurement does not satisfy a threshold associated with the verification data, the machine-readable instructions cause the client to isolate the network application.

Example 15 includes the apparatus of any one or more of examples 7-14, further including a verifier to calculate a run time integrity measurement of the network application and compare the run time integrity measurement of the network application to the verification data.

Example 16 includes a method comprising obtaining verification data corresponding to a network application from a server, verifying the network application based on policy data included in the verification data, if the verification of the network application is successful, allowing network traffic between a client and the network application, and if the verification of the network application is not successful, at least one of isolating the network application or preventing traffic between the client and the network application.

Example 17 includes the method of example 16, wherein the verification data includes identity information including a code hash or an organization code signing public key certificate.

Example 18 includes the method of any one or more of examples 16-17, further including reverifying the network application in response to an API call.

Example 19 includes the method of example 18, wherein reverifying the network application includes calculating a run time integrity measurement of the network application and comparing it to the verification data.

Example 20 includes the method of example 19, further including wherein if the run time integrity measurement does not satisfy a threshold associated with the verification data, isolating the network application.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus for attestation verification comprising:
interface circuitry;
machine readable instructions; and
programmable circuitry to execute the machine readable instructions to:
obtain verification data corresponding to a network application from a server;
verify the network application based on policy data included in the verification data;
if verification of the network application is successful, allow network traffic between the programmable circuitry and the network application; and
if the verification of the network application is not successful, at least one of isolate the network application or prevent traffic between the programmable circuitry and the network application.

2. The apparatus of claim 1, wherein the verification data includes identity information including a code hash or an organization code signing public key certificate.

3. The apparatus of claim 1, wherein the programmable circuitry has read-only access to the server.

4. The apparatus of claim 1, wherein the machine readable instructions cause the programmable circuitry to reverify the network application in response to an API call.

5. The apparatus of claim 4, wherein reverifying the network application includes calculating a run time integrity measurement of the network application and comparing it to the verification data.

6. The apparatus of claim 5, wherein if the run time integrity measurement does not satisfy a threshold associated with the verification data, the machine readable instructions causes the programmable circuitry to isolate the network application.

7. A system comprising:
a server including a memory to store verification data corresponding to a network application; and
a client including a machine-readable instructions to cause the client to:
obtain the verification data corresponding to the network application from the memory;
verify the network application based on policy data included in the verification data;
if verification of the network application is successful, allow network traffic between the client and the network application; and
if the verification of the network application is not successful, at least one of isolate the network application or prevent traffic between the client and the network application.

8. The system of claim 7, wherein the verification data includes identity information including a code hash or an organization code signing public key certificate.

9. The system of claim 7, wherein the network application is a first network application and wherein the server is coupled to a control plane, the server further including a configurator to append the memory with second verification data corresponding to a second network application.

10. The system of claim 7, wherein the client has read-only access to the server.

11. The system of claim 7, wherein a plurality of clients have read-only access to the server.

12. The system of claim 7, further including wherein the machine-readable instructions cause the client to reverify the network application in response to an API call.

13. The system of claim 12, wherein reverifying the network application includes calculating a run time integrity measurement of the network application and comparing it to the verification data.

14. The system of claim 13, wherein if the run time integrity measurement does not satisfy a threshold associated with the verification data, the machine-readable instructions cause the client to isolate the network application.

15. The system of claim 7, further including a verifier to calculate a run time integrity measurement of the network application and compare the run time integrity measurement of the network application to the verification data.

16. A method comprising:
obtaining verification data corresponding to a network application from a server;
verifying the network application based on policy data included in the verification data;
if the verification of the network application is successful, allowing network traffic between a client and the network application; and
if the verification of the network application is not successful, at least one of isolating the network application or preventing traffic between the client and the network application.

17. The method of claim 16, wherein the verification data includes identity information including a code hash or an organization code signing public key certificate.

18. The method of claim 16, further including reverifying the network application in response to an API call.

19. The method of claim 18, wherein reverifying the network application includes calculating a run time integrity measurement of the network application and comparing it to the verification data.

20. The method of claim 19, further including wherein if the run time integrity measurement does not satisfy a threshold associated with the verification data, isolating the network application.
